(19) United States
(12) Patent Application Publication
(10) Pub. No.: US 2013/0112299 A1
(43) Pub. Date: May 9, 2013

(54) AIR CONDITIONER AND ION GENERATION DEVICE

(71) Applicant: Yukimasa Kanazawa, Osaka-shi (JP)

(72) Inventor: Yukimasa Kanazawa, Osaka-shi (JP)

(73) Assignee: SHARP KABUSHIKI KAISHA, Osaka-shi, Osaka (JP)

(21) Appl. No.: 13/809,627

(22) PCT Filed: Apr. 26, 2011
(86) PCT No.: PCT/JP2011/060154

§ 371 Date: Jan. 11, 2013

(30) Foreign Application Priority Data
Jul. 13, 2010 (JP) 2010-158622

(51) Int. Cl. H01J 27/02

(52) U.S. Cl. CPC H01J 27/02
USPC 137/602; 250/423 R

(57) ABSTRACT

An ion generator is provided with a casing configured to form a flow path for air and an ion generation unit detachably disposed in the casing and configured to discharge ions into the air. The ion generation unit is provided with a front face-side ion generation section and a rear face-side ion generation section which are disposed with a spacing there between, and a connection cover section configured to connect the front face-side ion generation section and the rear face-side ion generation section. One end of the front face-side ion generation section and one end of the rear face-side ion generation section are positioned to be separated from each other in the flow path. The other end of the front face-side ion generation section and the other end of the rear face-side ion generation section are connected to each other by the connection cover section.

### TECHNICAL FIELD

The present invention generally relates to an air conditioner and an ion generation device, more specifically, relates to an air conditioner discharging ions together with air and an ion generation device detachably disposed in such air conditioner.

### BACKGROUND ART

As a conventional air conditioner, for example, an electrical apparatus with an ion generation function has been disclosed in Japanese Patent Laying-Open No. 2007-29497 (PTL 1) for the purpose of efficiently discharging generated ions to air even though a flow direction of wind varies according to an air volume. In the electrical apparatus with an ion generation function disclosed in PTL 1, an ion generation device is mounted in an air cleaner serving as the electrical apparatus.

### CITATION LIST

### Patent Literature

PTL 1: Japanese Patent Laying-Open No. 2007-29497

### SUMMARY OF INVENTION

### Technical Problem

Generally, as multiple persons stay for a long time in a tightly-closed room such as an office room, a conference room or the like, pollution particles in the room increase due to carbon dioxide exhaled with aspiration, smoke of cigarettes, dust and the like. In this situation, harmful substances unfavorable to human bodies spread in air, thereby, an ion generator is applied for the purpose of inhibiting such harmful substances to a low concentration. By means of ions (positive and/or negative ions) discharged by the ion generator into the room, it is possible to eliminate bacteria or inactivate virus floating in air.

In this case, by increasing the concentration of ions discharged into the room, the bacteria or virus sterilization effect will be improved. Thereby, in recent years, it has been expected an ion generator capable of discharging ions at a higher concentration together with air.

The ion generator is provided with an air blower which is configured to blow air into the room and an ion generation device which is disposed in a flow path for air to be sent by the air blower and is configured to discharge ions into the air circulating through the flow path. In order to improve the concentration of ions to be discharged into the room, there has been considered to increase the number of ions to be generated by the ion generation device. Thereby, it is necessary to enhance a discharge capacity of the ion generation device, increase the number of discharge times thereof, or improve an ion generation efficiency thereof.

In this case, however, it is necessary to apply continuously a high voltage to electrodes for generating the discharge. Therefore, the electrodes deteriorate as time elapses, which makes it difficult to maintain the ions to be released into the room at a high concentration. Thus, it is necessary to dispose the ion generation device in the ion generator as a detachable unit so as to exchange the unit periodically.

On the other hand, as an approach to improve the concentration of ions to be discharged into the room, it has been considered to increase the number of ion generation sections to be mounted in the ion generation device. In this case, the ions become saturated as the number thereof reaches to or beyond a defined amount, thereby, it is difficult to significantly increase the concentration of ions. In this regard, such approach is applied to dispose a plurality of ion generation sections oppositely with a spacing present between each other so as to globally spread ions discharged from the ion generation device in the flow path for air.

In this case, since the ion generation device is disposed as a detachable unit, it is necessary to unify the plurality of ion generation sections by using a connection section. However, depending on the way of disposing the connection section, it is possible to bring adverse effects on the air flow in the flow path, leading to a problem that ions may not be discharged efficiently into the room.

To solve the problems described above, it is, therefore, an object of the present invention to provide an air conditioner and an ion generation device which discharge efficiently ions with the ion generation device being disposed as a detachable unit.

### Solution to Problem

The air conditioner according to the present invention includes a main body section configured to form a flow path for air, and an ion generation device configured to discharge ions into the air circulating in the flow path. The ion generation device is detachably disposed in the main body section. The ion generation device is provided with a first ion generation section and a second ion generation section which are disposed with a spacing therebetween and are configured to generate ions, and a connection section configured to connect the first ion generation section and the second ion generation section. The first ion generation section includes one end and the other end, and the second ion generation section includes one end and the other end. The one end of the first ion generation section and the one end of the second ion generation section are positioned to be separated from each other in the flow path. The other end of the first ion generation section and the other end of the second ion generation section are connected to each other by the connection section.

According to the air conditioner configured as mentioned above, since the other end of the first ion generation section and the other end of the second ion generation section are connected to each other by the connection section, it is possible to dispose the ion generation device having a plurality of ion generation sections as a detachable unit. Further, since the one end of the first ion generation section and the one end of the second ion generation section are positioned to be separated from each other in the flow path, the air flow at the one ends will not be disturbed by the connection section.

Accordingly, it is possible to release efficiently the ions discharged from the ion generation device.

It is preferable that the main body section includes an inner wall configured to define the flow path. The main body section is formed with a recess section recessed from the inner wall for housing the connection section. According to the air conditioner configured as mentioned above, it is possible to inhibit the air flow from being disturbed by the connection section at the other ends of the first ion generation section and the second ion generation section.

It is preferable that the connection section includes a surface extending in connection with the inner wall. According to the air conditioner configured as mentioned above, it is possible to further efficiently inhibit the air flow from being disturbed by the connection section at the other ends of the first ion generation section and the second ion generation section.

It is preferable that the air conditioner is further provided with a fan which is housed in the main body section. The fan is configured to deliver air from an inner circumferential side thereof toward an outer circumferential side thereof when being rotated so as to circulate the air in the flow path. The main body section includes a scrolling face. The scrolling face extends while curving over an outer circumference of the fan when viewed from a rotation axis direction of the fan for guiding the air delivered from the fan along a circumferential direction. The recess section is disposed at an extension to the scrolling face in a rotation direction of the fan.

According to the air conditioner configured as mentioned above, the air guided along the circumferential direction by the scrolling face is gradually accelerated along the rotation direction of the fan, thereby, on the wall of the extension to the scrolling face, the wind speed becomes greater. According to the present invention, by housing the connection section in the recess section disposed at such position, it is possible to efficiently prevent the air flow from being disturbed by the connection section.

It is preferable that an electrical wiring extending between the first ion generation section and the second ion generation section is housed in the connection section. According to the air conditioner configured as mentioned above, it is possible to utilize the connection section which connects the first ion generation section and the second ion generation section to each other to set the electrical wiring therebetween.

It is preferable that the air conditioner is further provided with a fan which is housed in the main body section. The fan is configured to deliver air from an inner circumferential side thereof toward an outer circumferential side thereof when being rotated so as to circulate the air in the flow path. A space where the air delivered from the fan circulates and ions are released into the air is formed between the first ion generation section and the second ion generation section. In a rotation axis direction of the fan, a range where the space is formed, is contained in a range where the fan is disposed. According to the air conditioner configured as mentioned above, it is possible to efficiently deliver the air from the fan into the space where the ions are released.

It is preferable that the air conditioner is further provided with a fan which is housed in the main body section. The fan is configured to deliver air from an inner circumferential side thereof toward an outer circumferential side thereof when being rotated so as to circulate the air in the flow path. The one ends of the first ion generation section and the second ion generation section are disposed at an extension to a tangent line tangent to an outer circumferential edge of the fan when viewed from a rotation axis direction of the fan.

According to the air conditioner configured as mentioned above, along with the rotations of the fan, the air is sent out to the direction of the tangent line tangent to the outer circumferential edge of the fan. According to the present invention, since the one ends of the first ion generation section and the second ion generation section positioned separately from each other are disposed at the extension to the tangent line tangent to the outer circumferential edge of the fan, it is possible to smoothly circulate the air flow sent from the fan.

It is preferable that the air conditioner is further provided with a fan which is housed in the main body section. The fan is configured to deliver air from an inner circumferential side thereof toward an outer circumferential side thereof when being rotated so as to circulate the air in the flow path. The main body section is formed with an air outlet configured to discharge air together with ions into a room. The main body section includes a scrolling face, and a first guiding face and a second guiding face. The scrolling face extends while curving over an outer circumference of the fan when viewed from a rotation axis direction of the fan for guiding the air delivered from the fan along a circumferential direction. The first guiding face and the second guiding face extend respectively from both ends of the scrolling face toward the air outlet for guiding the air toward the air outlet. The ion generation device is disposed at a position where the width between the first guiding face and the second guiding face is the least.

According to the air conditioner configured as mentioned above, since the ion generation device is disposed at a position where the flow path is the narrowest when viewed from the rotation axis direction of the fan, it is possible to discharge ions in a way of spreading globally in the flow path for the air.

An ion generation device according to the present invention is detachably disposed in an air conditioner and is configured to discharge ions into air delivered from the air conditioner. The ion generation device is provided with a first ion generation section and a second ion generation section which are disposed with a spacing therebetween and are configured to generate ions, and a connection section configured to connect the first ion generation section and the second ion generation section. The first ion generation section and the second ion generation section include one ends which are disposed to be separated from each other, and the other ends which are connected to each other by the connection section.

According to the air conditioner configured as mentioned above, it is possible to dispose the ion generation device having a plurality of ion generation sections as a detachable unit. Moreover, it is possible to inhibit the connection section from disturbing the air flow inside the air conditioner where the ion generation device is mounted.

### Advantageous Effects of Invention

As described above, according to the present invention, it is possible to provide an air conditioner and an ion generation device which discharge efficiently ions with the ion generation device being disposed as a detachable unit.

### BRIEF DESCRIPTION OF DRAWINGS

FIG. 1 is a perspective view illustrating an ion generator in an embodiment of the present invention;

FIG. 2 is a perspective view illustrating a state of exchanging an ion generation unit in the ion generator of FIG. 1;

FIG. 3 is a section view illustrating the ion generator along line of FIG. 1;

FIG. 4 is a section view illustrating the ion generator along line IV-IV of FIG. 1;

FIG. 5 is a perspective view illustrating the ion generation unit mounted in the ion generator of FIG. 1;

FIG. 6 is a section view illustrating the ion generation unit along line VI-VI of FIG. 5;

FIG. 7 is a section view illustrating the ion generator along line VII-VII of FIG. 1;

FIG. 8 is an enlarged section view illustrating a portion encircled by two-dot chain line VIII of FIG. 3;

FIG. 9 is a top view illustrating the ion generator when viewed from a direction denoted by arrow IX of FIG. 1;

FIG. 10 is a section view illustrating the ion generator along line X-X of FIG. 1; and

FIG. 11 is a perspective view illustrating a modification of the ion generation unit of FIG. 5.

### DESCRIPTION OF EMBODIMENTS

An embodiment according to the present invention will be described with reference to the drawings. The same reference signs are assigned to the same or corresponding members in the drawings hereinafter.

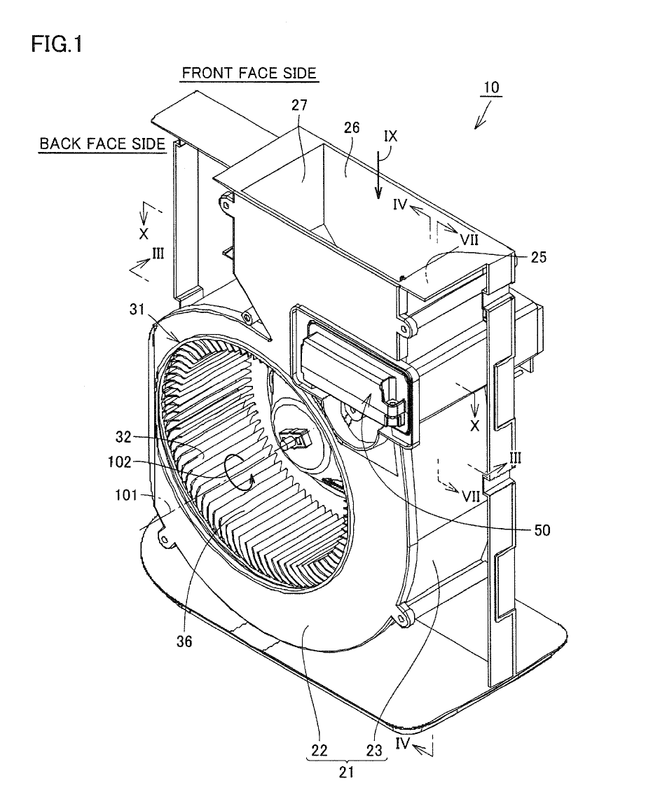

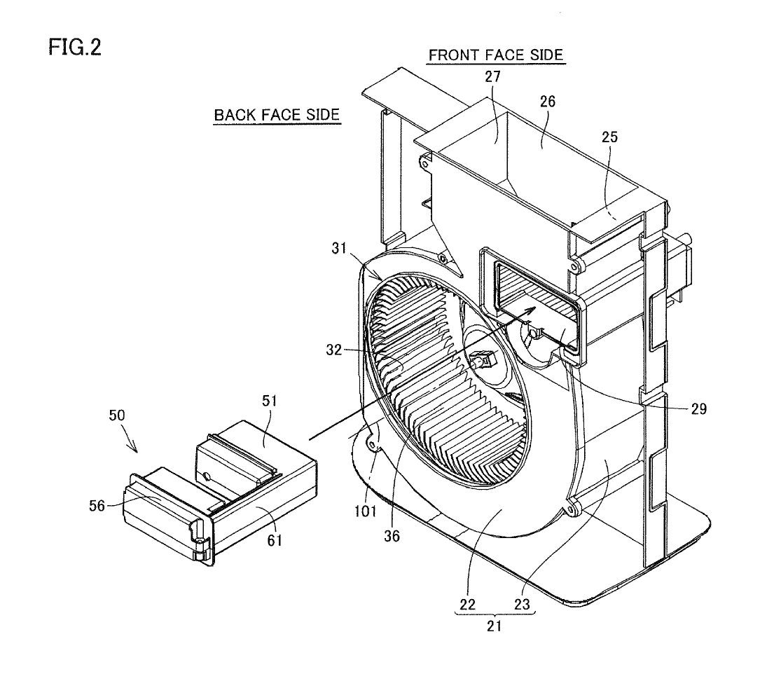

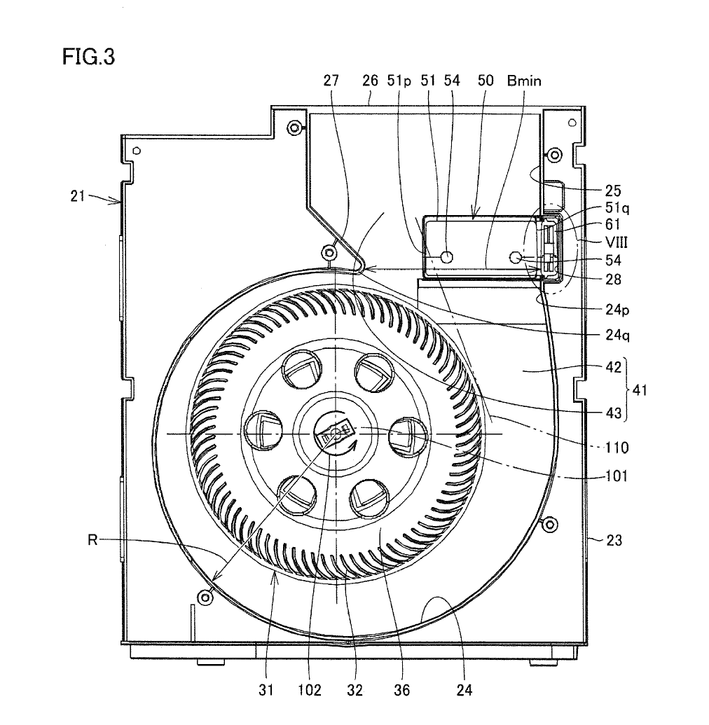

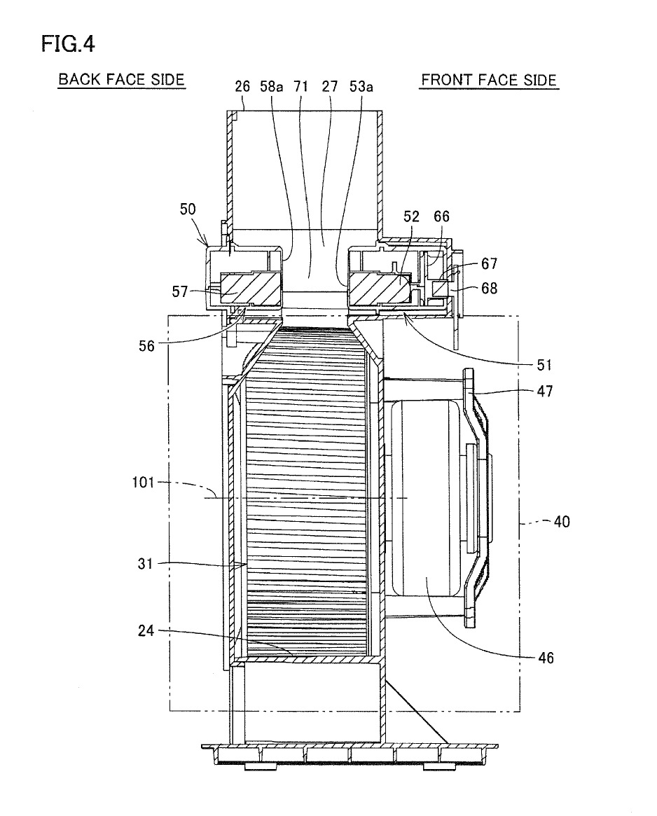

FIG. 1 is a perspective view illustrating an ion generator in an embodiment of the present invention. FIG. 2 is a perspective view illustrating a state of exchanging an ion generation unit in the ion generator of FIG. 1. FIG. 3 is a section view illustrating the ion generator along line III-III of FIG. 1. FIG. 4 is a section view illustrating the ion generator along line IV-IV of FIG. 1. In the drawings, an outer cover serving as an outer appearance of the ion generator is not illustrated.

With reference to FIGS. 1 to 4, an ion generator 10 has functions of releasing into the room positive ions H⁺(H₂O)ₙ (where n is any integral number containing zero) and negative ions O₂⁻(H₂O)ₘ (where m is any integral number containing zero), and inactivating or sterilizing virus in air by the released ions.

Firstly, the structure of ion generator 10 will be described. Ion generator 10 includes a casing 21, a sirocco fan 31, and an ion generation unit 50.

Casing 21 is composed of a casing main body 23 and a casing cover 22. Casing main body 23 is disposed at a front face side of ion generator 10, and casing cover 22 is disposed at a rear face side of ion generator 10. Casing cover 22 is configured to occlude an opening section of casing main body 23 from the rear face side of ion generator 10.

Casing 21 is formed with an air outlet 26 and an unit inserting section 29. Air outlet 26 is formed to open vertically at an upper face side. The cross section of air outlet 26 is rectangular. Air sent by sirocco fan 31 is discharged into the room through air outlet 26. As illustrated in FIG. 2, unit inserting section 29 is formed to open at the rear face side of casing 21. As illustrated in FIG. 1, ion generation unit 50 is inserted into unit inserting section 29.

Casing 21 forms a flow path 41 for air. Flow path 41 circulates the air sent by sirocco fan 31 toward air outlet 26. Air outlet 26 is disposed as an end of flow path 41. Flow path 41 is defined by casing main body 23 and casing cover 22 in combination.

Sirocco fan 31 is housed in casing 21. Sirocco fan 31 is configured to suck air in the room and blow the air toward flow path 41.

Sirocco fan 31 includes a plurality of fan blades 32. Sirocco fan 31 has an overall outer appearance having a substantially cylindrical shape of a cylinder, and the plurality of fan blades 32 are disposed at a circumferential surface of the substantially cylindrical shaped cylinder. Sirocco fan 31 rotates about a virtual central axis 101 illustrated in the drawings along a direction illustrated by an arrow 102. The plurality of fan blades 32 are disposed as centering about central axis 101 with a spacing between each other. Sirocco fan 31 is disposed to extend along a direction where central axis 101 joins the rear face side of ion generator 10 and the front face side thereof. Sirocco fan 31 is disposed at a lower side vertical to air outlet 26. Sirocco fan 31 is disposed in such a way that central axis 101 overlaps with air outlet 26 in the vertical direction.

Ion generator 10 is provided with a motor 46 and a motor supporting section 47. Motor 46 is installed at the front face side of casing 21 with motor supporting section 47 interposed therebetween. An output shaft of motor 46 is connected to sirocco fan 31. Motor 46 drives sirocco fan 31 to rotate. Motor 46, motor supporting section 47 and sirocco fan 31 construct an air blower 40 (See FIG. 4) configured to form an air flow in flow path 41. It is also acceptable that air blower 40 is configured to have a cross flow (transverse) fan in place of sirocco fan 31.

With reference to FIG. 3, an inner circumferential side of sirocco fan 31, that is an inner side of the plurality of fan blades 32 aligned in the circumferential direction, is formed with a sucking section 36. An outer circumferential side of sirocco fan 31, that is an outer side of the plurality of fan blades 32 aligned in the circumferential direction, is formed with a scrolling section 42. When being rotated, sirocco fan 31 sucks air from the room into sucking section 36, and thereafter blows the sucked air toward scrolling section 42.

Casing 21 has a scrolling face 24. When viewed from the axial direction of central axis 101, scrolling face 24 extends while curving over an outer circumference of sirocco fan 31. Scrolling face 24 has a radius R centering about central axis 101. Scrolling face 24 is fainted in such a way that radius R thereof becomes greater gradually along the rotation direction of sirocco fan 31.

Scrolling face 24 has an one end 24p and the other end 24q. One end 24p is disposed at an end portion of scrolling face 24 in the rotation direction of sirocco fan 31. The other end 24q is disposed at an end portion of scrolling face 24 in a counter direction to the rotation direction of sirocco fan 31. Scrolling face 24 is formed to have an angle smaller than 360 degrees about central axis 101 from one end 24p to the other end 24q.

Casing 21 has a guiding face 25 and a guiding face 27. Guiding face 25 and guiding face 27 are disposed facing each other. Guiding faces 25 and 27 extend between scrolling face 24 and air outlet 26. Guiding face 25 extends from one end 24p of scrolling face 24 toward air outlet 26. Guiding face 27 extends from the other end 24q of scrolling face 24 toward air outlet 26.

Flow path 41 is composed of scrolling section 42 and a blowing section 43. Scrolling section 42 is disposed relatively at an upstream side of flow path 41, and blowing section 43 is disposed relatively at a downstream side of flow path 41. When viewed from the axial direction of central axis 101, scrolling section 42 is formed between sirocco fan 31 and scrolling face 24. When viewed from the axial direction of central axis 101, blowing section 43 is formed between guiding face 25 and guiding face 27. Blowing section 43 is opened to the room at air outlet 26.

With reference to FIG. 1 and FIG. 2, ion generation unit 50 is configured to be detachable from casing 21. As illustrated in FIG. 2, ion generation unit 50 is inserted into unit inserting section 29 so as to be installed in casing 21. Ion generation unit 50 is inserted into unit inserting section 29 along the axial direction of central axis 101.

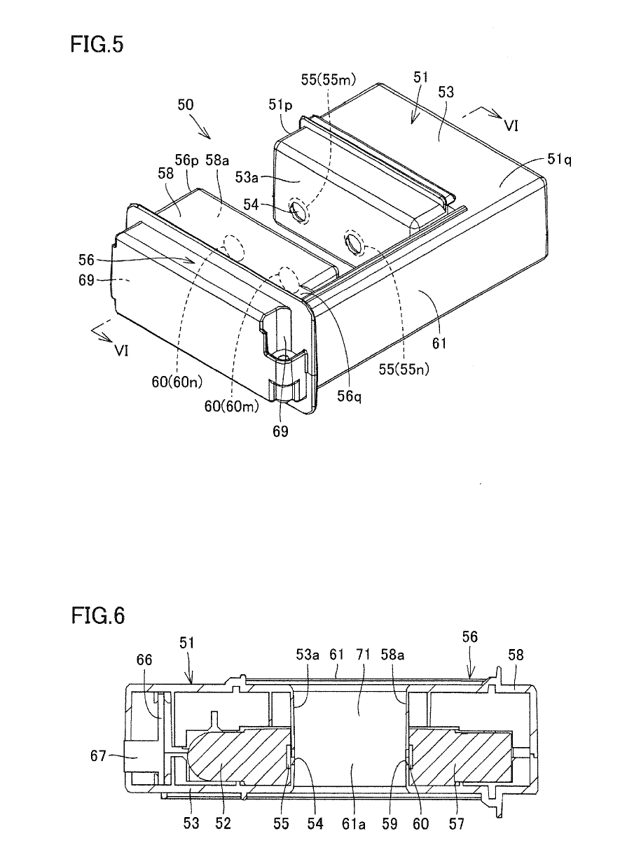

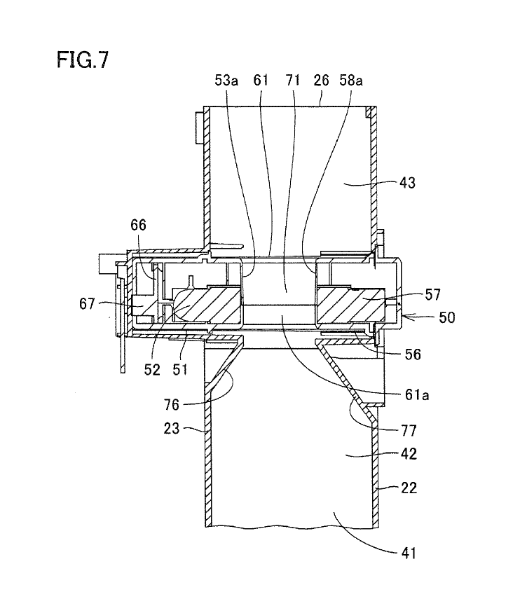

FIG. 5 is a perspective view illustrating the ion generation unit mounted in the ion generator of FIG. 1. FIG. 6 is a section view illustrating the ion generation unit along line VI-VI of FIG. 5. FIG. 7 is a section view illustrating the ion generator along line VII-VII of FIG. 1.

With reference to FIGS. 3 to 7, ion generation unit 50 includes a front face-side ion generation section 51, a rear face-side ion generation section 56, and a connection cover section 61.

Front face-side ion generation section 51 and rear face-side ion generation section 56 are disposed with a spacing therebetween. Front face-side ion generation section 51 and rear face-side ion generation section 56 are disposed facing each other. Front face-side ion generation section 51 and rear face-side ion generation section 56 are disposed in flow path 41. Front face-side ion generation section 51 is disposed at the front face side of ion generator 10, and rear face-side ion generation section 56 is disposed at the rear face side of ion generator 10. A space 71 is formed between front face-side ion generation section 51 and rear face-side ion generation section 56. Front face-side ion generation section 51 and rear face-side ion generation section 56 are disposed in such a way that space 71 therebetween occupies a part of flow path 41.

Connection cover section 61 is disposed to connect front face-side ion generation section 51 and rear face-side ion generation section 56. Front face-side ion generation section 51 and rear face-side ion generation section 56 are unified through the intermediary of connection cover section 61.

With reference to FIG. 5 and FIG. 6, front face-side ion generation section 51 is composed of a plasma discharging section 52 and a cover section 53. Rear face-side ion generation section 56 is composed of a plasma discharging section 57 and a cover section 58.

Cover sections 53 and 58 are configured to cover plasma discharging sections 52 and 57, respectively. Cover section 53 has an opposing face 53a. Cover section 58 has an opposing face 58a facing opposing face 53a. Space 71 is formed between opposing face 53a and opposing face 58a. Opposing face 53a is formed thereon two ion releasing ports 54, and opposing face 58a is formed thereon two ion releasing ports 59. Opposing face 53a has a rectangular shape with a long side thereof extending in the alignment direction of two ion releasing ports 54. Opposing face 58a has a rectangular shape with a long side thereof extending in the alignment direction of two ion releasing ports 59.

Plasma discharging section 52 has a dielectric electrode 55m for generating positive ions and a dielectric electrode 55n for generating negative ions (referred to as dielectric electrode 55 in the case there is no need to distinguish them from each other). Though not shown in the drawings, dielectric electrode 55 is composed of a discharging electrode having a sharpened shape, and an opposite electrode surrounding the discharging electrode. Dielectric electrode 55 is disposed adjacent to ion releasing port 54. By applying a high voltage to dielectric electrode 55, the positive and negative ions are generated and released to space 71 through ion releasing port 54.

Plasma discharging section 57 has a dielectric electrode 60m for generating positive ions and a dielectric electrode 60n for generating negative ions (referred to as dielectric electrode 60 in the case there is no need to distinguish them from each other). Dielectric electrode 60 has the same structure as dielectric electrode 55 mentioned above. By applying a high voltage to dielectric electrode 60, the positive and negative ions are generated and released to space 71 through ion releasing port 59.

In the present embodiment, dielectric electrode 55m and dielectric electrode 60n are disposed to confront each other in the direction where opposing face 53a and opposing face 58a face each other, and dielectric electrode 55n and dielectric electrode 60m are disposed to confront each other in the direction where opposing face 53a and opposing face 58a face each other.

Ion generation unit 50 is not limited to the embodiment mentioned above. For example, it is acceptable that dielectric electrode 55m and dielectric electrode 60m are disposed to confront each other in the direction where opposing face 53a and opposing face 58a face each other, and dielectric electrode 55n and dielectric electrode 60n are disposed to confront each other in the direction where opposing face 53a and opposing face 58a face each other. It is also acceptable that dielectric electrode 55 and dielectric electrode 60 are disposed with a deviation therebetween in the direction where opposing face 53a and opposing face 58a face each other.

A substrate 66 is housed in cover section 53. Substrate 66 is disposed at an opposite side to plasma discharging section 57 relative to plasma discharging section 52. Substrate 66 is mounted with an electric member, such as a switching element, for applying a high voltage to dielectric electrodes 55 and 60. Substrate 66 is connected respectively with plasma discharging section 52 and plasma discharging section 57 through electrical wirings (not shown).

Substrate 66 is provided with an unit connecting section 67. Meanwhile, as illustrated in FIG. 4, casing 21 is provided with a main body connecting section 68 connectable to unit connecting section 67.

In the state where ion generation unit 50 is installed in casing 21, the connection of unit connecting section 67 to main body connecting section 68 allows the main body of ion generator 10 and ion generation unit 50 to be connected electrically.

Cover section 58 is formed with a removing holder 69 for holding ion generation unit 50 when removing it out of unit inserting section 29.

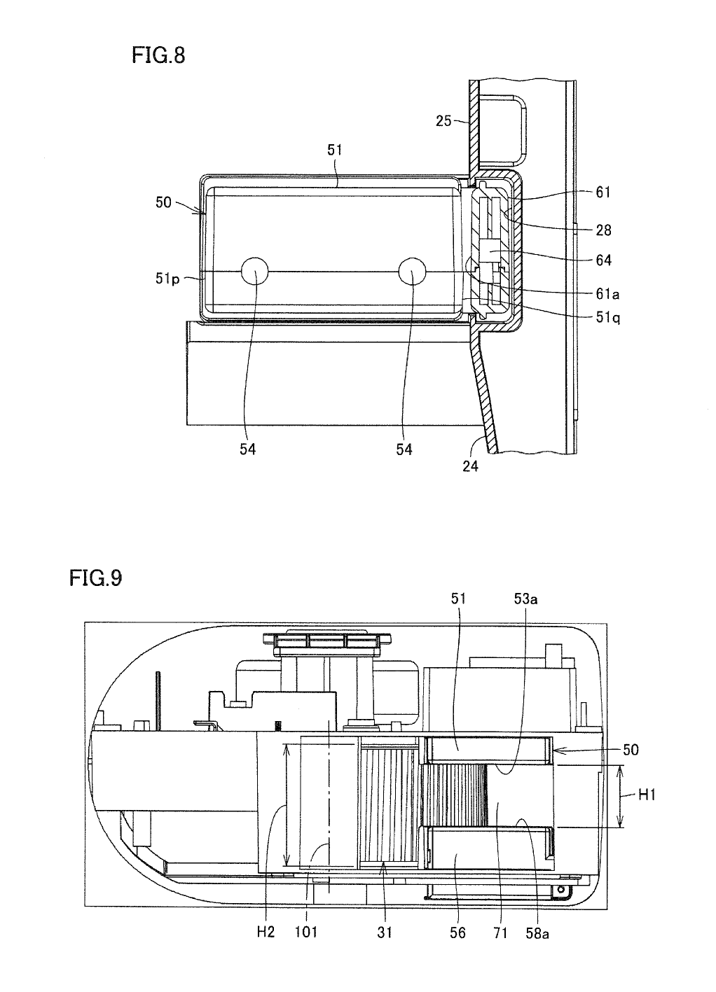

FIG. 8 is an enlarged section view illustrating a portion encircled by two-dot chain line VIII of FIG. 3. With reference to FIGS. 3 to 8, front face-side ion generation section 51 has one end 51p and the other end 51q. One end 51p and the other end 51q are disposed at both ends of the long sides of opposing face 53a, respectively. Rear face-side ion generation section 56 has one end 56p and the other end 56q. One end 56p and the other end 56q are disposed at both ends of the long sides of opposing face 58a, respectively. One end 51p and one end 56p are disposed to confront each other in the direction where opposing face 53a and opposing face 58a face each other, and the other end 51q and the other end 56q are disposed to confront each other in the direction where opposing face 53a and opposing face 58a face each other.

Connection cover section 61 is configured to connect the other end 51q of front face-side ion generation section 51 and the other end 56q of rear face-side ion generation section 56 to each other. More specifically, connection cover section 61 is formed to join together cover section 53 and cover section 58 between the other end 51q and the other end 56q. Connection cover section 61 is formed to extend linearly in the direction where opposing face 53a and opposing face 58a face each other.

Connection cover section 61 is formed with a hollow section 64 to make an internal portion of cover section 53 in communication with an internal portion of cover section 58. The electrical wiring (not shown) connecting substrate 66 and plasma discharging section 57 is held inside hollow section 64.

One end 51p of front face-side ion generation section 51 and one end 56p of rear face-side ion generation section 56 are disposed to be separated from each other in flow path 41. When viewed from the rotation axis direction of sirocco fan 31, that is the axial direction of central axis 101, one end 51p of front face-side ion generation section 51 and one end 56p of rear face-side ion generation section 56 are disposed at an extension to a tangent line 110 tangent to an outer circumferential edge of sirocco fan 31 (See FIG. 3).

Casing 21 is formed with a recess section 28. Recess section 28 is formed to recess from an inner wall of casing 21 which defines flow path 41. More specifically, recess section 28 is formed to recess from guiding face 25 which defines blowing section 43. Recess section 28 has a shape of a groove extending from the rear face side of casing 21 where unit inserting section 29 opens along the insertion direction of ion generation unit 50.

Connection cover section 61 is disposed inside recess section 28. Connection cover section 61 has a side face 61a serving as a surface. Side face 61a defines space 71 together with opposing face 53a and opposing face 58a. In the state where connection cover section 61 is housed in recess section 28, side face 61a extends in connection with the inner wall (guiding face 25) of casing 21 which defines flow path 41.

With reference to FIG. 7, casing 21 has a guide wall 76 and a guide wall 77. Guide wall 76 and guide wall 77 are disposed neighboring to front face-side ion generation section 51 and rear face-side ion generation section 56, respectively, at the downstream side of the air flow. Guide wall 76 and guide wall 77 are formed to protrude from the wall surface of casing 21 toward flow path 41. Guide wall 76 extends obliquely between the wall surface of casing 21 and opposing face 53a. Guide wall 77 extends obliquely between the wall surface of casing 21 and opposing face 58a.

Subsequently, the operations of ion generator 10 in FIG. 1 will be explained.

As air blower 40 is actuated, sirocco fan 31 rotates about central axis 101. In accordance with the rotations of sirocco fan 31, the indoor air is introduced into sucking section 36 and is delivered to scrolling section 42. The air delivered to scrolling section 42, while the direction of the air being converted by scrolling face 24, flows from scrolling section 42 toward blowing section 43 while being accelerated gradually along the rotation direction of sirocco fan 31. At this moment, the positive and negative ions released from plasma discharging sections 52 and 57 are discharged through ion releasing ports 54 and 59 into the air passing through space 71 located between front face-side ion generation section 51 and rear face-side ion generation section 56. The air charged with the ions is released to the room via air outlet 26.

In ion generator 10 according to the present embodiment, for the purpose of improving the concentration of ions discharged into the air, the two ion generation sections, namely front face-side ion generation section 51 and rear face-side ion generation section 56 are disposed oppositely. However, by disposing connection cover section 61 to connect front face-side ion generation section 51 and rear face-side ion generation section 56, it is possible to handle ion generation unit 50 as a detachable exchange unit.

Herein, since connection cover section 61 is disposed only at the other ends 51q and 56q of front face-side ion generation section 51 and rear face-side ion generation section 56; thereby, it is possible to prevent the air flow at the side of one ends 51p and 56p disposed in flow path 41 from being disturbed by connection cover section 61.

In the present embodiment, one ends 51p and 56p of front face-side ion generation section 51 and rear face-side ion generation section 56 are disposed at the extension to tangent line 110 tangent to the outer circumferential edge of sirocco fan 31. In accordance with the rotations of sirocco fan 31, the air is delivered to the direction of the tangent line to the outer circumferential edge of sirocco fan 31. Thereby, by disposing at the extension to tangent line 110 one ends 51p and 56p of front face-side ion generation section 51 and rear face-side ion generation section 56 positioned with a spacing therebetween, it is possible to circulate smoothly the air which has been delivered along the linear direction of tangent line 110. Moreover, since nothing is present at such position to disturb the air flow, it is possible to attain such effects as reducing noises occurred in actuating ion generator 10.

Connection cover section 61 is disposed in recess section 28 formed in casing 21. Side face 61a of connection cover section 61 facing flow path 41 extends in connection with guide face 25 of casing 21. Thereby, it is possible to prevent connection cover section 61 from being a resistance to the air flow circulating in flow path 41, enabling the air to be discharged into the room smoothly. In particular, since guide face 25 formed with recess section 28 is disposed at the extension to scrolling face 24 in the flow direction of the air, the flowing speed of the air becomes greater near the wall of guide face 25. In the present embodiment, connection cover section 61 is disposed as not to disturb the air flow at such position, it is possible to maintain the high air-blowing performance of ion generator 10.

Hereinafter, the description will be carried out on the more detailed structure of ion generator 10 in FIG. 1.

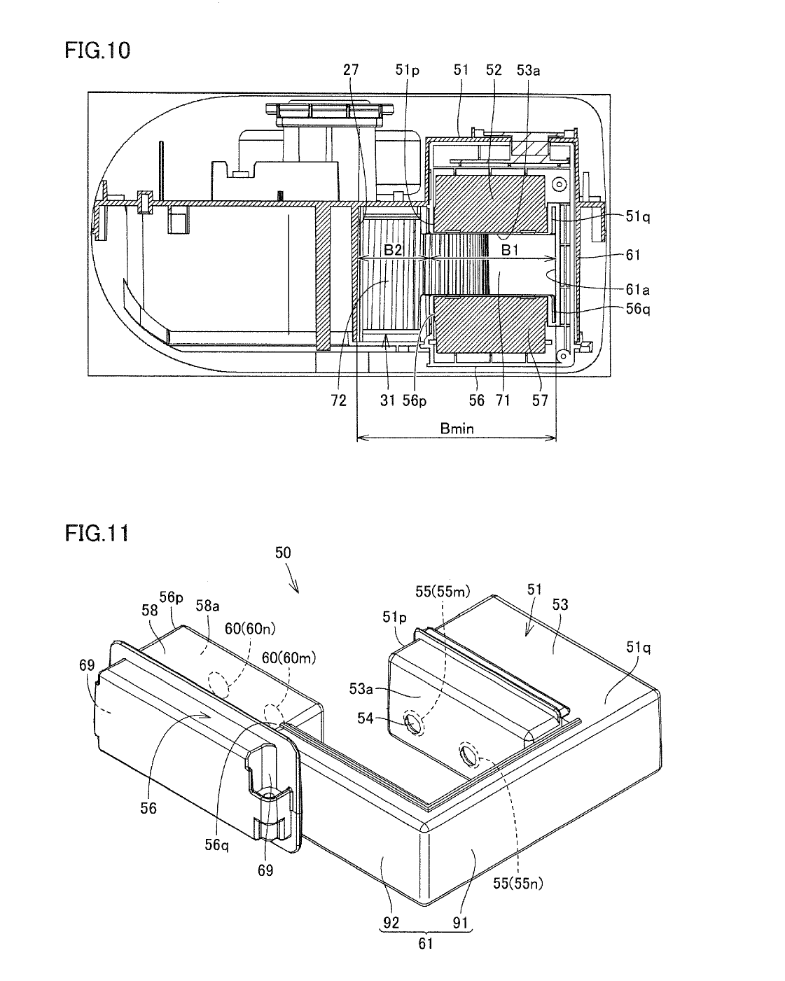

FIG. 9 is a top view illustrating the ion generator when viewed from a direction denoted by arrow IX of FIG. 1. FIG. 10 is a section view illustrating the ion generator along line X-X of FIG. 1.

With reference to FIG. 9, in the plan view of ion generator 10 (viewed into air outlet 26 from the front side thereof), sirocco fan 31 partially overlaps with front face-side ion generation section 51 and rear face-side ion generation section 56. In the present embodiment, in the rotation axis direction of sirocco fan 31, namely the axial direction of central axis 101, a range H1 where space 71 between front face-side ion generation section 51 and rear face-side ion generation section 56 is formed is contained in a range H2 where sirocco fan 31 is disposed. According to such configuration, since a width for delivering the air from sirocco fan 31 is range H2, it is possible to deliver efficiently the air into space 71 to which the ions are released.

With reference to FIG. 3 and FIG. 10, the width between guide face 25 and guide face 27 varies in the flow direction of the air circulating in flow path 41. In the present embodiment, ion generation unit 50 is disposed at such a position that the width between guide face 25 and guide face 27 is a minimum value Bmin. According to such configuration, since ion generation unit 50 is disposed at a position where flow path 41 is the narrowest, it is possible to discharge ions in a way of spreading globally in flow path 41.

FIG. 10 illustrates the section view obtained by sectioning the position where ion generation unit 50 is disposed by a plane orthogonal to the air flow direction. Flow path 41 in the section view has a T shape formed by space 71 between front face-side ion generation section 51 and rear face-side ion generation section 56, and a space 72 which is formed between one ends 51p and 56p of front face-side ion generation section 51 and rear face-side ion generation section 56 and guide face 27. In the direction where guide face 27 and guide face 25 face each other, space 71 has a width of B1 and space 72 has a width of B2 (B2<B1, B1+B2=Bmin).

Supposing that front face-side ion generation section 51 and rear face-side ion generation section 56 are connected at both one ends 51p and 56p and the other ends 51q and 56q, it is necessary to embed a connection cover section in guide face 27 at not only the other ends 51q and 56q but also at one ends 51p and 56p. Since the width of ion generation unit 50 is determined by the distance between guide face 25 and guide face 27, an ion generation unit in this case will become greater than ion generation unit 50 illustrated in FIG. 5. However, in the present embodiment, connection cover section 61 is disposed only at the other ends 51q and 56q of front face-side ion generation section 51 and rear face-side ion generation section 56. Thereby, the shape and the dimension of ion generation unit 50 will not be restricted by the sectional shape of flow path 41, allowing ion generation unit 50 to be made smaller.

To summarize the description on the structure of ion generator 10 in the abovementioned embodiment according to the present invention, ion generator 10 serving as an air conditioner in the present embodiment includes casing 21 serving as a main body section configured to form flow path 41 for air and ion generation unit 50 serving as an ion generation device for discharging ion to air circulating in flow path 41. Ion generation unit 50 is detachably disposed in casing 21. Ion generation unit 50 is provided with front face-side ion generation section 51 serving as a first ion generation section for generating ions and rear face-side ion generation section 56 serving as a second ion generation section for generating ions, which are disposed with a spacing therebetween, and with connection cover section 61 serving as a connection section configured to connect front face-side ion generation section 51 and rear face-side ion generation section 56. Front face-side ion generation section 51 includes one end 51p and the other end 51q, and rear face-side ion generation section 56 includes one end 56p and the other end 56q. One end 51p of front face-side ion generation section 51 and one end 56p of rear face-side ion generation section 56 are positioned to be separated from each other in flow path 41. The other end 51q of front face-side ion generation section 51 and the other end 56q of rear face-side ion generation section 56 are connected to each other by connection cover section 61.

Ion generation unit 50 serving as an ion generation device in the embodiment according to the present invention is detachably disposed in ion generator 10 serving as an air conditioner and is configured to discharge ions into air released from ion generator 10. Ion generation unit 50 is provided with front face-side ion generation section 51 for generating ions and rear face-side ion generation section 56 for generating ions, which are disposed with a spacing therebetween, and with connection cover section 61 configured to connect front face-side ion generation section 51 and rear face-side ion generation section 56. Front face-side ion generation section 51 includes one end 51p and the other end 51q, and rear face-side ion generation section 56 includes one end 56p and the other end 56q. One end 51p of front face-side ion generation section 51 and one end 56p of rear face-side ion generation section 56 are disposed to be separated from each other. The other end 51q of front face-side ion generation section 51 and the other end 56q of rear face-side ion generation section 56 are connected to each other by connection cover section 61.

According to ion generator 10 and ion generation unit 50 configured as mentioned above in the embodiment of the present invention, by disposing connection cover section 61 to connect front face-side ion generation section 51 and rear face-side ion generation section 56, it is possible to handle ion generation unit 50 as a detachable exchange unit. Further, since connection cover section 61 is disposed only at the other ends 51q and 56q of front face-side ion generation section 51 and rear face-side ion generation section 56, it is possible to circulate smoothly the air at one ends 51p and 56p disposed in flow path 41. Accordingly, it is possible to efficiently deliver ions released to space 71 into the room together with the air, and it is possible to improve the concentration of ions supplied to the room.

Furthermore, since connection cover section 61 is disposed only at the other ends 51q and 56q of front face-side ion generation section 51 and rear face-side ion generation section 56, the shape and the dimension of ion generation unit 50 will not be restricted by the sectional shape of flow path 41. Thereby, it is possible to make ion generation unit 50 smaller for saving space inside ion generator 10.

In the present embodiment, the present invention is described as being applied to ion generator 10 but not limited thereto, it is acceptable to apply the present invention to various apparatuses, such as a dehumidifier, a humidifier, an air conditioner, an air cleaner and the like, for adjusting or conditioning air conditions.

Hereinafter, the description will be carried out on various modifications of ion generation unit 50 in FIG. 5.

FIG. 11 is a perspective view illustrating a modification of the ion generation unit in FIG. 5. With reference to FIG. 11, in the present modification, front face-side ion generation section 51 and rear face-side ion generation section 56 are disposed with a deviation therebetween in the alignment direction of the two ion releasing ports 54 (ion releasing ports 59) so that both do not face each other. One end 51p and one end 56p are disposed with a deviation therebetween in the direction where opposing face 53a and opposing face 58a face each other, and the other end 51q and the other end 56q are disposed with a deviation therebetween in the direction where opposing face 53a and opposing face 58a face each other.

Connection cover section 61 is disposed to connect the other end 51q of front face-side ion generation section 51 and the other end 56q of rear face-side ion generation section 56 to each other. Connection cover section 61 is formed into an L shape by a first section 91 and a second section 92 in combination. First section 91 is formed by extending linearly from the other end 51q in the direction where opposing face 53a and opposing face 58a face each other. Second section 92 is formed by bending from first section 91 and extending toward the other end 56q.

In the case where ion generation unit 50 according to the present modification is applied to ion generator 10, it is also possible to obtain the same effects as described above.

In addition, it is acceptable for ion generation unit 50 to have three or more ion generation sections. For example, it is acceptable to have a plurality of ion generation sections laminated in ion generation unit 50 of FIG. 5 along the air flow direction, and it is also acceptable to further dispose another ion generation section in parallel to the side of one ends 51p and 56p of front face-side ion generation section 51 and rear face-side ion generation section 56.

It should be understood that the foregoing description of the embodiments has been presented for the purpose of illustration and description but not limited in all aspects. It is intended that the scope of the present invention is not limited to the description mentioned above but defined by the scope of the claims and encompasses all modifications equivalent in meaning and scope to the claims.

### INDUSTRIAL APPLICABILITY

The present invention is generally applicable to an electrical apparatus such as an ion generator, a dehumidifier, a humidifier, an air conditioner, an air cleaner or the like.

### REFERENCE SIGNS LIST

10: ion generator; 21: casing; 22: casing cover; 23: casing main body; 24: scrolling face; 24p: one end; 24q: the other end; 25, 27: guiding face; 26: air outlet; 28: recess section; 29: unit inserting section; 31: sirocco fan; 32: fan blade; 36: sucking section; 40: air blower; 41: flow path; 42: scrolling section; 43: blowing section; 46: motor; 47: motor supporting section; 50: ion generation unit; 51: front face-side ion generation section; 51p, 56p: one end; 51q, 56q: the other end; 52, 57: plasma discharging section; 53, 58: cover section; 53a, 58a: opposing face; 54, 59: ion releasing port; 55, 55m, 55n, 60, 60m, 60n: dielectric electrode; 56: rear face-side ion generation section; 61: connection cover section; 61a: side face; 64: hollow section; 66: substrate; 67: unit connecting section; 68: main body connecting section; 69: removing holder; 71, 72: space; 76, 77: guide wall; 91: first section; 92: second section; 101: central axis; 110: tangent line.

1. An air conditioner comprising:
a main body section configured to form a flow path for air; and
an ion generation device detachably disposed in said main body section and configured to discharge ions into the air circulating in said flow path, wherein
said ion generation device is provided with a first ion generation section and a second ion generation section which are disposed with a spacing therebetween and are configured to generate ions, and a connection section configured to connect said first ion generation section and said second ion generation section; and
said first ion generation section and said second ion generation section include one ends which are positioned to be separated from each other in said flow path and the other ends which are connected to each other by said connection section.

2. The air conditioner according to claim 1, wherein
said main body section includes an inner wall configured to define said flow path, and
said main body section is formed with a recess section recessed from said inner wall for housing said connection section.

3. The air conditioner according to claim 2, wherein said connection section includes a surface extending in connection with said inner wall.

4. The air conditioner according to claim 2 further comprising a fan which is housed in said main body section and is configured to deliver air from an inner circumferential side of the fan toward an outer circumferential side thereof when being rotated so as to circulate the air in said flow path, wherein
said main body section includes a scrolling face which extends while curving over an outer circumference of said fan when viewed from a rotation axis direction of said fan for guiding the air delivered from said fan along a circumferential direction, and
said recess section is disposed at an extension to said scrolling face along a rotation direction of said fan.

5. The air conditioner according to claim 1, wherein an electrical wiring extending between said first ion generation section and said second ion generation section is housed in said connection section.

6. The air conditioner according to claim 1 further includes a fan which is housed in said main body section and is configured to deliver air from an inner circumferential side of the fan toward an outer circumferential side thereof when being rotated so as to circulate air in said flow path,
a space where the air delivered from said fan circulates and ions are released into the air is formed between said first ion generation section and said second ion generation section, and
in a rotation axis direction of said fan, a range where said space is formed is contained in a range where said fan is disposed.

7. The air conditioner according to claim 1 further comprising a fan which is housed in said main body section and is configured to deliver air from an inner circumferential side of the fan toward an outer circumferential side thereof when being rotated so as to circulate air in said flow path, and
said one ends of said first ion generation section and said second ion generation section are disposed at an extension to a tangent line tangent to an outer circumferential edge of said fan when viewed from a rotation axis direction of said fan.

8. The air conditioner according to claim 1 further includes a fan which is housed in said main body section and is configured to deliver air from an inner circumferential side of the fan toward an outer circumferential side thereof when being rotated so as to circulate air in said flow path,
said main body section is formed with an air outlet for discharging air together with ions into a room,
said main body section includes a scrolling face which extends while curving over an outer circumference of said fan when viewed from a rotation axis direction of said fan for guiding the air delivered from said fan along a circumferential direction, and a first guiding face and a second guiding face which extend respectively from both ends of said scrolling face toward said air outlet for guiding the air toward said air outlet, and
said ion generation device is disposed at a position where the width between said first guiding face and said second guiding face is the least.

9. An ion generation device detachably disposed in an air conditioner and configured to discharge ions into air delivered from the air conditioner, comprising:
a first ion generation section and a second ion generation section which are disposed with a spacing therebetween and are configured to generate ions, and
a connection section configured to connect said first ion generation section and said second ion generation section,
said first ion generation section and said second ion generation section includes one ends which are disposed to be separated from each other, and the other ends which are connected to each other by said connection section.
